(19) United States
(12) Patent Application Publication
(10) Pub. No.: US 2010/0036734 A1
(43) Pub. Date: Feb. 11, 2010

(54) Delivering Advertisement Messages to a User by the Use of Idle Screens of Electronic Devices

(76) Inventor: Yang Pan, (US)

Correspondence Address: Yang Pan, Shimao Riviera Garden, Wei Fang Rd. (W), Lane 1, Block 9, Unit 8A, Shanghai, 200122, CN

(21) Appl. No.: 12/189,215

(22) Filed: Aug. 11, 2008

(51) Int. Cl. G06Q 30/00; G06F 3/048; G06F 15/16

(52) U.S. Cl. 705/14.55; 715/798; 715/847; 709/203

(57) ABSTRACT

A method is disclosed by the use of an idle display screen of an electronic device to render one or a plurality of advertisement messages. The method requires no extra effort from a user since the displayed message is replaced by a default display screen when the first user's input action is received. The displayed message is being removed into an icon displayed in the default screen in a notable means to the user. In one embodiment, a display plane with the advertisement message is reduced progressively and is moved into the icon in a visible way to the user with a visible trajectory of the movement on the screen. The user attracted by the displayed message may actuate the icon containing at least the displayed message for a review. Further, the icon may include other advertisement messages. In another embodiment, an idle screen such as for example, a blanket screen is displayed when the device is idle. An advertisement message is displayed immediately after the user's first input action is received. The message is then removed into the icon in a user notable means. The user's reactions to the displayed messages are monitored and the messages to be displayed are adjusted in accordance with the user's reactions.

### CROSS-REFERENCE TO RELATED APPLICATIONS

Not applicable.

### BACKGROUND

1. Field of Invention

This invention relates generally to advertising. More specifically, the invention relates to methods and systems for providing advertisements by the use of idle screens of electronic devices.

2. Description of Prior Art

To provide information and communication services to various users, electronic devices with computing and communication means are widely used today. Many of these electronic devices are kept in a functioning state even when the user is not using the device in order to keep the device in touch with the communication network. Many devices simply display an idle screen with simple messages such as, for example, the time of the day, while the device is not being used. Many other devices simply display a blanket screen.

Although such an idle display is popular, such a display provides no or little useful information to the user who, however, has to glance at the display whenever he/she operates the device. It would be desirable to display advertisement messages so that it is nearly guaranteed that the user sees the messages.

U.S. Pat. Nos. 5,913,040, 6,317,789, 6,539,429 to Rakavy et al disclosed prior arts to utilize an idle screen of a mobile device to display advertisement messages, which are delivered to the user's device without user's notification. The messages are displayed preferably as a screen saver. U.S. Pat. No. 6,363,419 to Martin, Jr. et al disclosed a method to display useful or commercial information on an idle screen. The idle content screen is switched to the default display screen when a user's input action is received. US patent application 2004/0077340 by Forsyth and the application 2006/0156256 by Lee disclosed similar ways to use idle screen for displaying commercial information with the user's programmability on the displayed contents.

A default display screen is typically used as a gateway for a user to use an electronic device. It is not always desirable to have a different screen to present “useful” or “commercial” messages to a user. It is, in particularly, un-desirable that a user has to take specific efforts to navigate into the default screen of an electronic device. In U.S. Pat. No. 7,369,864 to Vaananen, an art is disclosed attempting to resolve the above mentioned issues. The electronic short messaging method is proposed with a reduced manipulation time required from a user. The user is shown the message automatically, and he or she may delete it or receive further information on it with one single press of a dedicated key.

Although the art disclosed by Vaananen simplifies the user's operation, it still requires a user's effort to make a selection with the dedicated key. In contrast, for a typical mobile device, a user's input action on any key or any portion of a touch-screen typically leads the user into the default screen immediately without much effort.

Accordingly, it is an object of the present invention to provide a method for displaying an advertisement message on an idle screen of an electronic device, which requires no additional effort from a user to navigate into a default screen of the device.

It is a further object of the present invention to provide a method that the displayed advertisement message is removed into an icon in the default screen in a user notable means when a user's input action is received.

It is still a further object of the present invention to provide a method that an icon representing a data file folder containing at least the displayed messages is displayed on the default screen and is accessible by the user. The icon may further contain other advertisement messages.

It is still a further object of the present invention to provide a method to adjust the advertisement messages in the folder dynamically based upon received user's input actions.

### SUMMARY OF THE INVENTION

To more effectively use the display screen during idle time of electronic devices, the present invention introduces an idle content display system. For example, when a mobile computing and communication device is not being used by the user the wireless computing device might display the advertisements. The present system comprises at least one advertising server operated by an advertisement broker and at least one electronic device with a display screen and a user input device. A mobile computing and communication device is used as an exemplary case in this disclosure. The method, however, applies to all electronic devices with a display screen, a user input device and a communication device. The server and the mobile device are connected by a wireless communication network, which can be a wireless internet or a telephony network in our preferred embodiment. The server is also connected to a plurality of advertisers who subscribe to the advertising broker for delivering the advertisement messages to users of mobile devices.

In one embodiment, a plurality of advertisement messages is sent by the server to the mobile device. The received messages are stored in a file storage system of the mobile device and are listed in a specific folder represented by an icon. The icon is displayed on the default screen of the device. When a display screen is idle, the advertisement messages are displayed sequentially. The screen is in an idle status if the device does not receive a user's input action and does not receive a calling message from the communication network.

A touch-screen type of device is used as an exemplary case. When a user starts to use the mobile device, he or she starts the operation by touching the screen which is typically in a status of an idle screen or more likely a blanket screen in most circumstances to save the power consumption. When the screen is touched, the display goes back to the default screen that has a user interface to guide one to navigate into application categories of the device. In the present invention, the advertisement messages are displayed sequentially when the device is idle. When the user starts to operate the device by touching the screen, the displayed message is removed in a way, which is notable to the user. For example, the advertisement message is displayed as an image in a plane. The size of the plane associated with the message is reduced progressively while it is being removed into an icon displayed in the default display screen. When the user touches the screen, the screen goes to default while the displayed message is being removed. One of inventive features is that the user notifies that the message is removed into a specific icon on the screen. If the user is attracted by the message displayed, he or she may select the icon for a further reviewing of messages in the folder. When the folder associated with the icon is opened, the user may decide to review the displayed message or other messages, which may intrigue the user.

In one aspect of the present invention, the icon displayed on the default screen associated with advertisements may include the displayed message only. After the first user's input action, the message is removed from the screen and is deposited inside the icon visually. If the user does not show any interest in the message by selecting the icon within a predetermined period of time, the icon can be deleted by the system. On the other hand, if the icon is indeed selected by the user, the displayed message is then re-displayed with added icons. The user may select at least one of such icons for more detailed information about the advertisement.

In another aspect of the present invention, the advertisement messages included in the folder represented by the icon are adjusted dynamically based upon the user's actions. For example, if the displayed message is not selected by a user in exceeding of a predetermined period of time, the message may be replaced by a new one delivered from the server. On the other hand, if the message is indeed selected by the user, more advertisement messages related to the displayed one may be ‘pushed’ to the device from the server and be presented to the user for a potential selection to review. For example, if the user selects the icon after viewing a promotion of a lunch in his or her office area, more advertisement messages related to lunch promotions from local restaurants are sent to the device.

In another embodiment of the present invention, the mobile device is displayed with an idle screen when idling. An advertisement message is displayed immediately after the device receives the user's first input action. The message is then removed automatically after being displayed briefly. The displayed message is removed in a notable way to the user. Such an embodiment has the advantage for saving power for the mobile device. The display time for the message has to be short for not interrupting the user's operation of mobile device. The message in such an implementation must be simple and be easily captured by the user.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a server used by an advertisement broker receiving real time advertisement messages from advertisers and sending to a plurality of electronic devices through communication networks.

FIG. 2 is a schematic diagram of an electronic device, an “advertisement message manager” (software module) is used to control the operations of delivering advertisement messages to the device and of presenting the messages to the user.

FIG. 3 is a schematic diagram of a displayed advertisement message that is removed into a displayed icon in the default screen after the first user's input action is received.

FIG. 4A is a schematic diagram of a series of display screens showing the changes from a default display screen to a screen with a plurality of icons representing various advertisement messages and further to a screen with the original displayed message re-displayed with more user selectable icons for the next level of detailed information.

FIG. 4B is a schematic diagram of two display screens showing the change from a default screen to a screen with the original displayed message re-displayed with more user selectable icons for the next level of detailed information.

FIG. 5 is a schematic diagram of a mobile device starting with an idle screen and presenting an advertisement message to the user after the first user's input action is received and subsequently removing the message into the displayed icon in the default screen in a notable way to the user. The idle screen is a blanket screen in such an exemplary illustration.

FIG. 6 is a flow diagram of an embodiment for delivering and presenting advertisement messages to a user.

FIG. 7 is a flow diagram of adjusting dynamically advertisement messages in the folder represented the icon based upon the user's input actions.

FIG. 8 is a flow diagram of another embodiment for delivering and presenting advertisement messages to a user. The idle screen is taken as a blanket screen in such an exemplary illustration.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

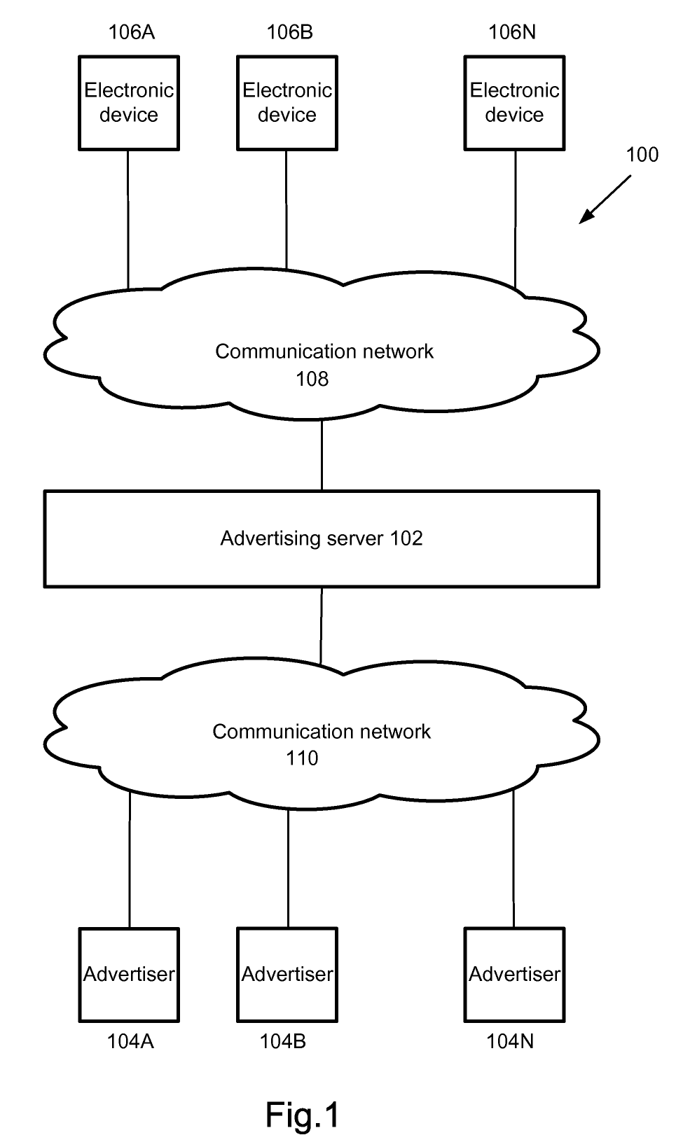

FIG. 1 is a schematic diagram of an exemplary communication system 100 for distributing advertisement messages. An advertising server 102 is used by an advertisement broker receiving real time advertisements from advertisers 104 and sending to a plurality of electronic devices 106. The electronic devices 106A, 106B, . . . , 106N can take various forms such as, for example, it can be a mobile computing and communication device which a user is carrying with. It can also be a general purpose computing device such as computers. In various embodiments, each electronic device may communicate with an advertising server 102 through a communication network 108. The communication network can take various forms such as the internet, a W-LAN and other suitable communication networks. A plurality of advertisers 104A, 104B, . . . , 104N may also communicate with the advertising server 102 over a communication network 110. In various embodiments network 108 and 110 may be the same network, however, in various other embodiments, the network 108 and 110 may be different networks. In various embodiment, the advertisers 104A, 104B, . . . , 104N may communicate with the advertising server 102 for a number of reasons, including, purchasing advertisement space and uploading advertisement messages. In the present invention, the advertisement messages from the advertisers to the advertising server are updated continuously on a real time base.

It should be noted that system depicted in FIG. 1 shows a single advertising server 102 for ease of illustration purpose only. Various embodiments may use multiple servers in a manner that is either apparent or transparent to the communication system and its users.

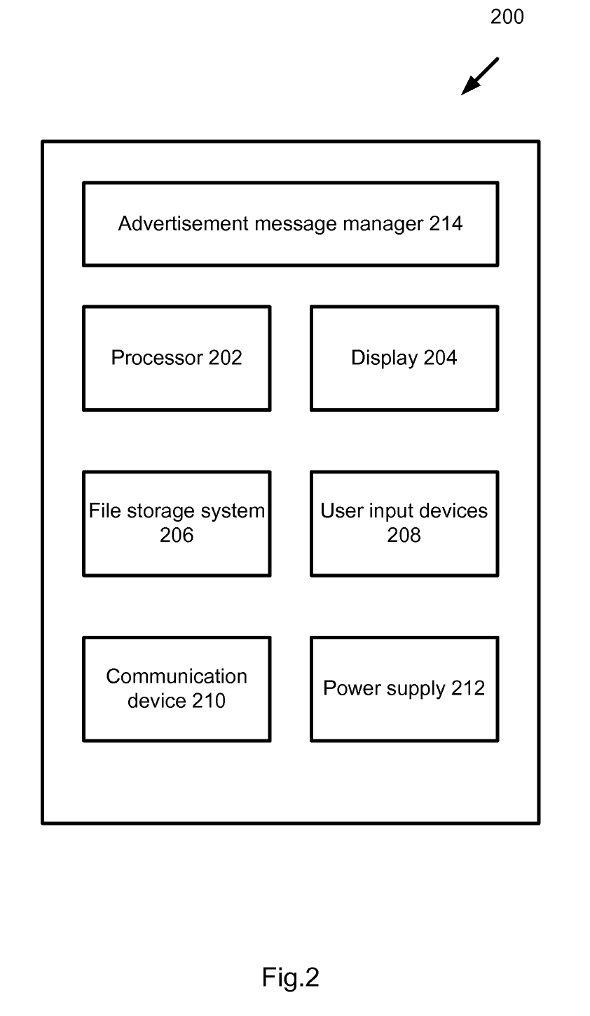

We take a mobile computing and communication device as an exemplary case to illustrate the present invention. It should be noted that the invention can be applied to any other electronic device such as a computer for these familiar with the art. As shown in FIG. 2, the mobile device 200 may comprise a processor 202 to control operations of the device, a display screen 204, such as, for example, a Liquid Crystal Display (LCD) screen and a file storage system 206. The file storage system 206 is typically a semiconductor flash memory device or a plurality of flash memory devices or a magnetic storage means as a hard disk driver. The file storage system may also include a cache to improve the data access time. The mobile device 200 further comprises a user input device or devices 208 as keys, touch pads or a rotational user interface as used in iPod from Apple Inc Cupertino Calif. The user input device can be integrated at least partially with the display screen in a specific implementation related to touch-screen type of display. A touch-screen is a display which can detect the location of touches within display area, usually performed either with the human hand or a stylus. The device 200 also includes a communication device module 210 to connect to the communication network. The communication network can take forms as a telephony network or the internet In one implementation, the mobile device is GSM mobile station. In other implementations, the mobile devices may be a UMTS, WAP, Teldesic, Inmarsat, Iridium, GPRS, CDMA, WCDMA mobile station. The mobile device may be connectable to a wireless internet network. The device is powered by a power supply 212 such as a battery.

A software module “advertisement message manager” 214 is used to control the operations for receiving and displaying advertisement messages delivered from the advertising server. The device being characterized in that, the software module is arranged to identify in coming advertisement messages, store the messages in the file system or display at least portion of messages directly on the display screen. The mobile device may further comprise a Global Positioning System (GPS) (not shown in the figure) to identify its position of a mobile device. Recently, GPS has been developed to the point where they are very inexpensive to implement in a mobile device. The employment of the GPS can assist the server to deliver location-based advertisement messages to the user.

In various embodiments of the invention, advertisements may include text, graphics, video, audio and multimedia messages. It should be appreciated that while advertisement messages are used herein as exemplary embodiments of the invention, any document may be used in accordance with the various embodiments. For instance, documents such as advertisements, content pages, search results, emails, IM messages, audio content or files, video contents or files, other data or applications that may reside on one or several of computer systems, or other definable concepts or content may be used. Thus although the use of advertisement messages are described herein as examples, other documents such as web pages may be targeted to viewers and displayed in accordance the various embodiments, e.g. as described herein with respect to advertisement messages.

It should be understood that an advertisement message as used herein may comprise audio and/or video signals, static and/or dynamic images, graphics, video, film, or other content that relate to one or more products, services, and/or entities, such as commercial entities. Advertisement messages may also comprise various visual features, including animation, sound etc., and may include text, such as in a text advertisement. Thus, the term “advertisement message” is used herein in its broadest sense to include any content or object intended for observation, use, or consumption by one or more persons for the purpose of marketing or promoting a product or service. While, advertisement messages are used for exemplary purpose, it should be understood that any audio and/or video content, such as television programming, may be used with the systems and methods described herein.

The term “idle screen” refers to the screen displayed when the mobile device is switched on and therefore capable of receiving a voice call or other forms of messages. The idle screen is the screen which is displayed when the user is not navigating to a particular function, nor actively using particular application, or a messaging application. The present invention is with an object to utilize the idle screen to display advertisement messages with no additional efforts from the user when he or she starts to operate the mobile device and wishes to be engaged with the device's standard user interfaces (default display screen) immediately.

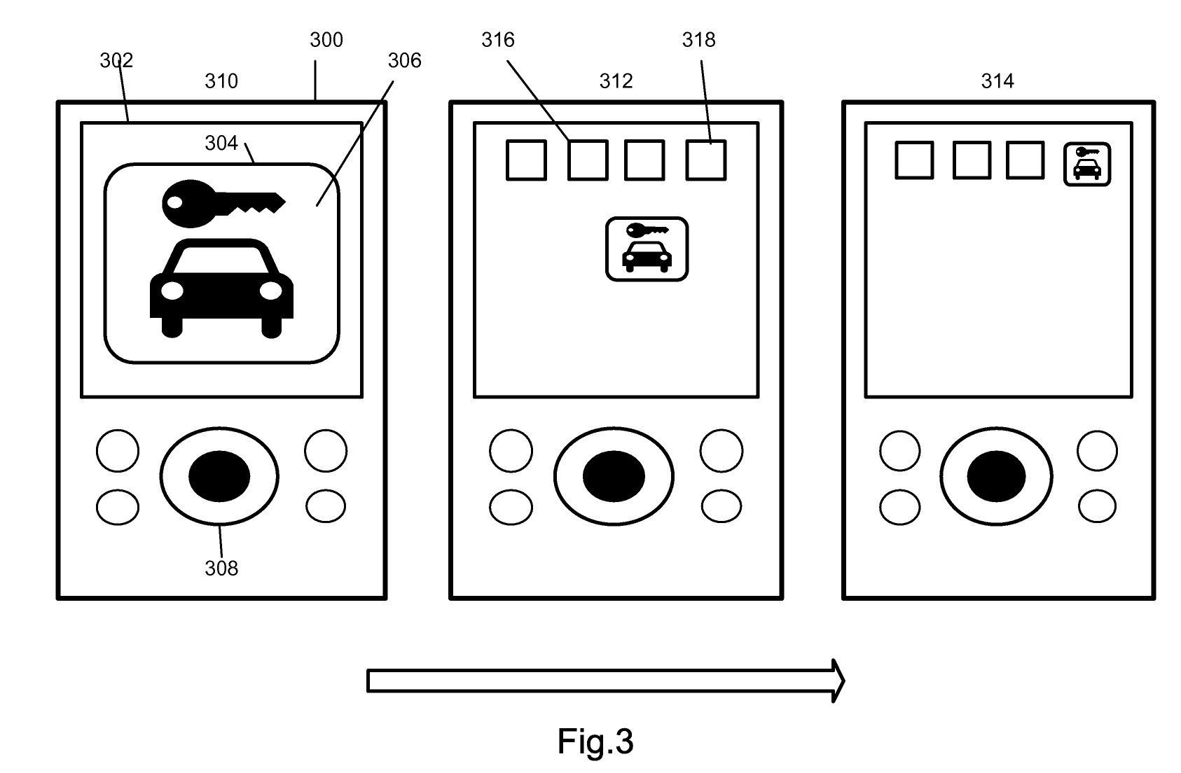

FIG. 3 is a schematic diagram of a displayed advertisement message that is removed into a displayed icon in the default screen after receiving the first user's input action. A mobile device 300 is with a display screen 302 and a displayed plane 304 for an advertising message 306. The device further comprises a user input device 308. A plurality of advertisement messages are delivered by the server and are stored in the file storage system of the mobile device. The messages are displayed sequentially on a screen of the idling device. An idle screen status is reached if no user input action and no incoming call is received after a predetermined period of time.

As shown in 310, a message is displayed on the idle screen with the clear visibility. The message displayed can take various forms including but not limited to, text, graphic, video and multimedia. The message needs to be simple and can catch the user's attentions in a short period of time. When a user's input action that is the first user's input action is received, the displayed message is removed in a user notable manner. The input action includes the user's action touching the screen when the touch-screen type of display is used. As shown in 312, the size of display plane 304 containing the displayed message 306 is reduced progressively. In the same time, the reduced plane with the message is moved towards a displayed icon with a visible trajectory till it is contained within or is overlapped with the icon as shown in 314. The movement of the message plane may be accompanied by an audio signal to attract the attention from the user. After the message plane is reduced and is contained within or is overlapped with the icon, special animation effects associated with the icon may be applied to further attract the user's attention such as, for example, the icon may be vibrated or be expanded first and then be recovered to its original shape and size. The user, with a single touching with the screen, navigates back to the default display for using the device. He or she can choose to ignore the message displayed without any additional effort. However, if the user is attracted by the message, he or she may actuate the icon and review the advertisement message further with next level of details. When the icon is selected, a list of other messages represented by respective icons is displayed in the second display screen. The user may choose to view other messages listed in the folder.

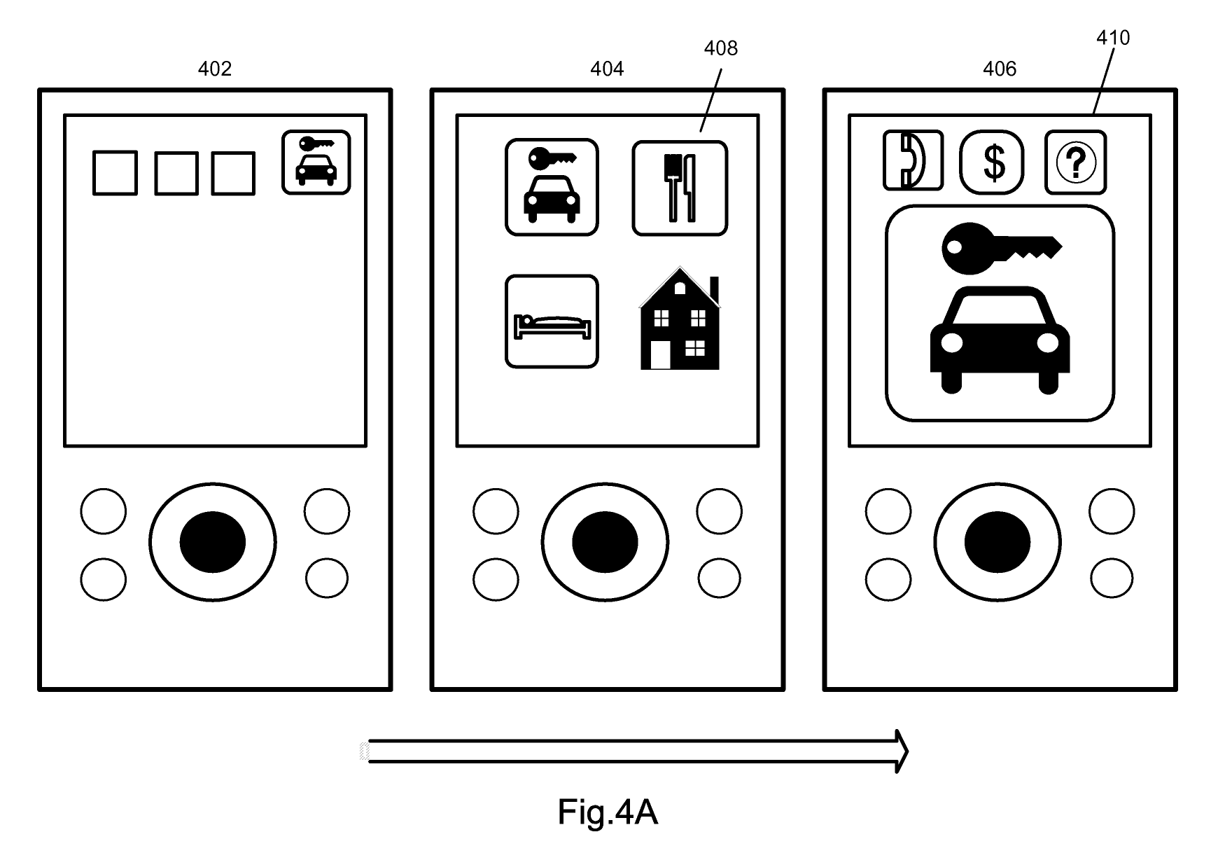

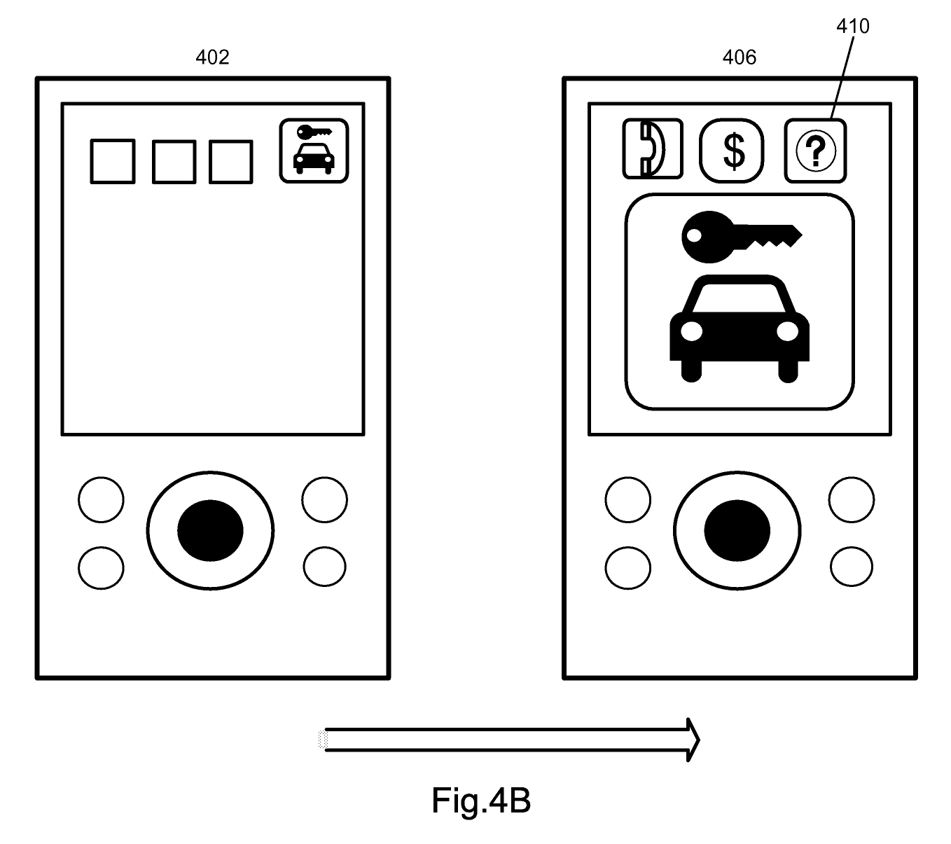

FIG. 4A is a schematic diagram of a series of display screens showing the changes from a default display screen to a screen with a plurality of icons representing various advertisement messages and further to a screen with the original displayed message re-displayed with more icons for next level of detailed information.

When the user selects the icon in the default display screen in 402, he or she enters into a displayed screen with a plurality of icons representing different advertisement messages as shown in 404. The displayed icons include the one representing the message just being displayed. The displayed icons further include ones (408) representing other advertisement messages. The user may choose one of them for a further reviewing. If the message just being displayed is selected by the user, the message is re-displayed on the screen as shown in 406 with additional icons (410) that lead the user to next level of details. A few exemplary cases are illustrated in the figure. An icon with a phone symbol, if selected, connects the user to the advertiser automatically for further information. It is not necessary for the user to key-in or write-in the phone number of the advertiser. An icon with a “$” may reveal purchasing information and lead the user to reserve and/or to purchase products or services associated with the advertisement message.

FIG. 4B is a schematic diagram showing a simpler embodiment of the present invention. The displayed icon includes the displayed message only. After the first user's input action, the message is removed into the icon visually. If the user does not show any interest in the message, the icon can be deleted after a predetermined period of time. On the other hand, if the icon is indeed selected by the user, the displayed message is then re-displayed with added icons. The user may select the icons for more detailed information about the advertisement.

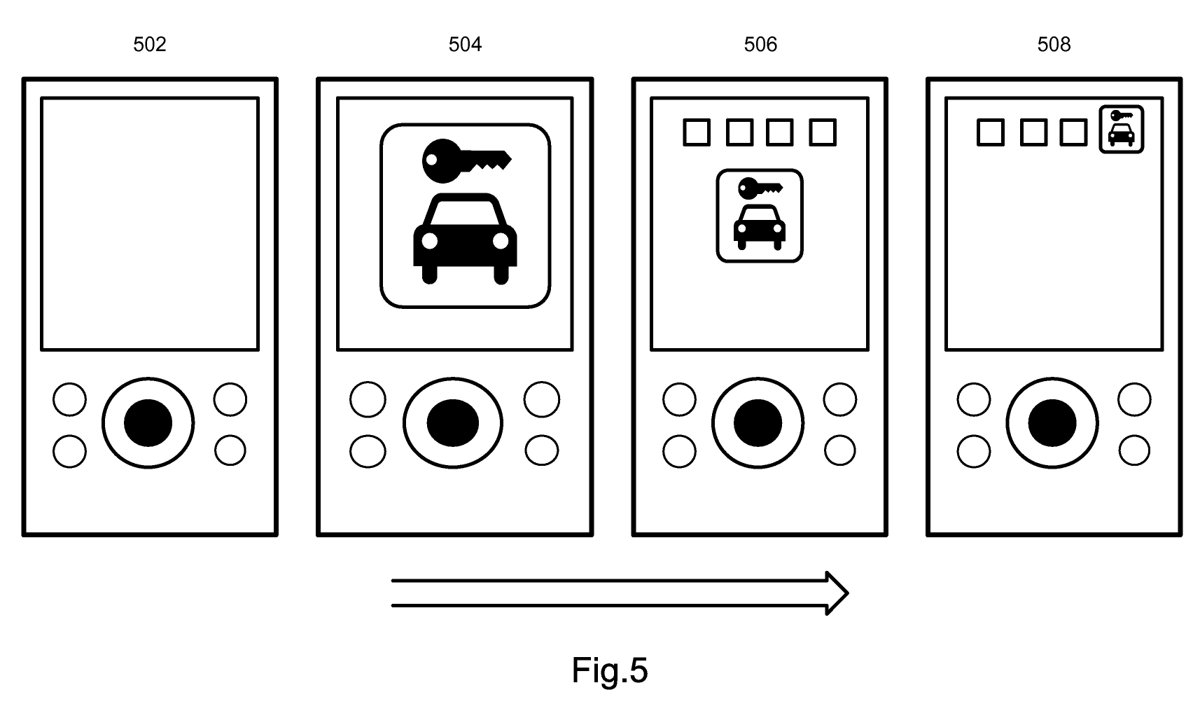

One of the potential issues associated with displaying a message using the idle screen is the increased power consumption, in particularly, if the message is a colorful image or takes a form of the multimedia files. In another embodiment of the present invention, the device displays an idle screen when it is idling. An exemplary case of a blanket screen is described for the purpose of illustration, which should not limit the scope of the present invention. The advertisement message is presented to the user only if the device detects that the user starts to operate the mobile device. FIG. 5 is a schematic diagram of the mobile device starting with a blanket screen (502) and presenting an advertisement message to the user after receiving the first user's input action (504) and subsequently removing the message into the icon in a notable way to the user (506) till the message is contained in or is overlapped with the icon (508). The message presented in such an implementation has to be simple in the sense that the user can capture the message in a short period of time. The message is then removed into an icon automatically in a way notable to the user. If the user wishes to be engaged with the default display screen, he or she can use it immediately after the message is removed, which does not require any additional further action from the user.

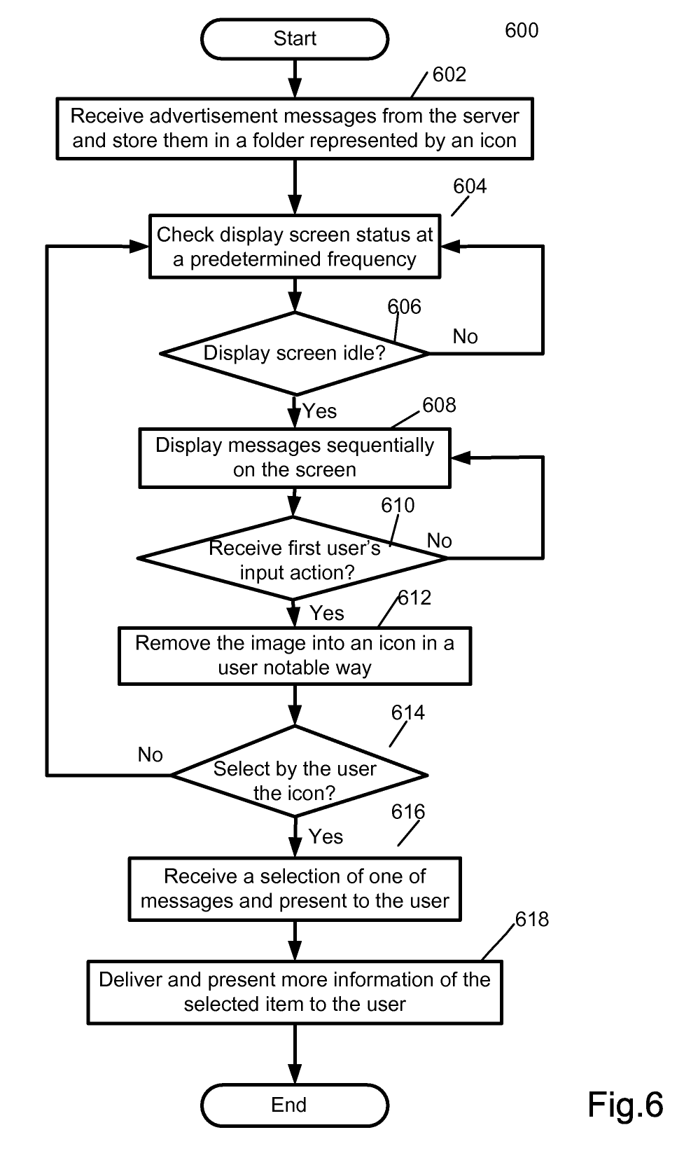

FIG. 6 is a flow diagram of an embodiment for delivering and presenting advertisement messages to the user by the use of an idle screen. The process 600 starts with a step 602 that the mobile device receives a plurality of advertisement messages through the communication network from the advertising server. The processor of the mobile device controls the receiving operation through the use of the software module “advertisement message manager” and then stores the messages in the file storage system of the mobile device. The messages can be stored in the main storage device as semiconductor flash memory devices or be stored directly in the cache of the device, which provides faster access time for the data. The transmission of the data can be carried out through a telephony network or through a wireless internet network. The transmission of data from a server to a client device is well known in the art. It should be noted that the server may select the advertisement messages based upon the user's profile, the time of the day, a location of the user and various other inputs deemed to be useful to generate advertisement messages for a specific user with higher probability to intrigue him or her.

The “advertisement message manager” operated by the processor checks regularly the status of the device in a step 604. A predetermined period of time after the user's latest action to the device is defined as the critical time for the device entering into the idle status. If such a status is reached in a step 606, the processor controls a sequential display of the stored messages in a step 608. At least one message is displayed at a time for a predefined period of time before it is replaced by another one. The displaying of the message may be disrupted by a user's input action or a call from the network followed typically by a user's input action in a step 610. If the first user's input action after the device is in the idling status is received, in a step 612, the displayed message is removed into an icon in the default display screen in a notable means to the user as depicted previously in FIG. 3. In a step 614, if the device detects that the user selects the icon for viewing the advertisement messages, the “advertisement message manager” is operated to display any selected message to the user in a step 616. Further, more detailed information may be presented to the user in a step 618. If no further input actions are detected after the user entering the folder by selecting the icon, the processor controls the device to check the next idle screen event based upon the dynamically adjusted advertisement messages.

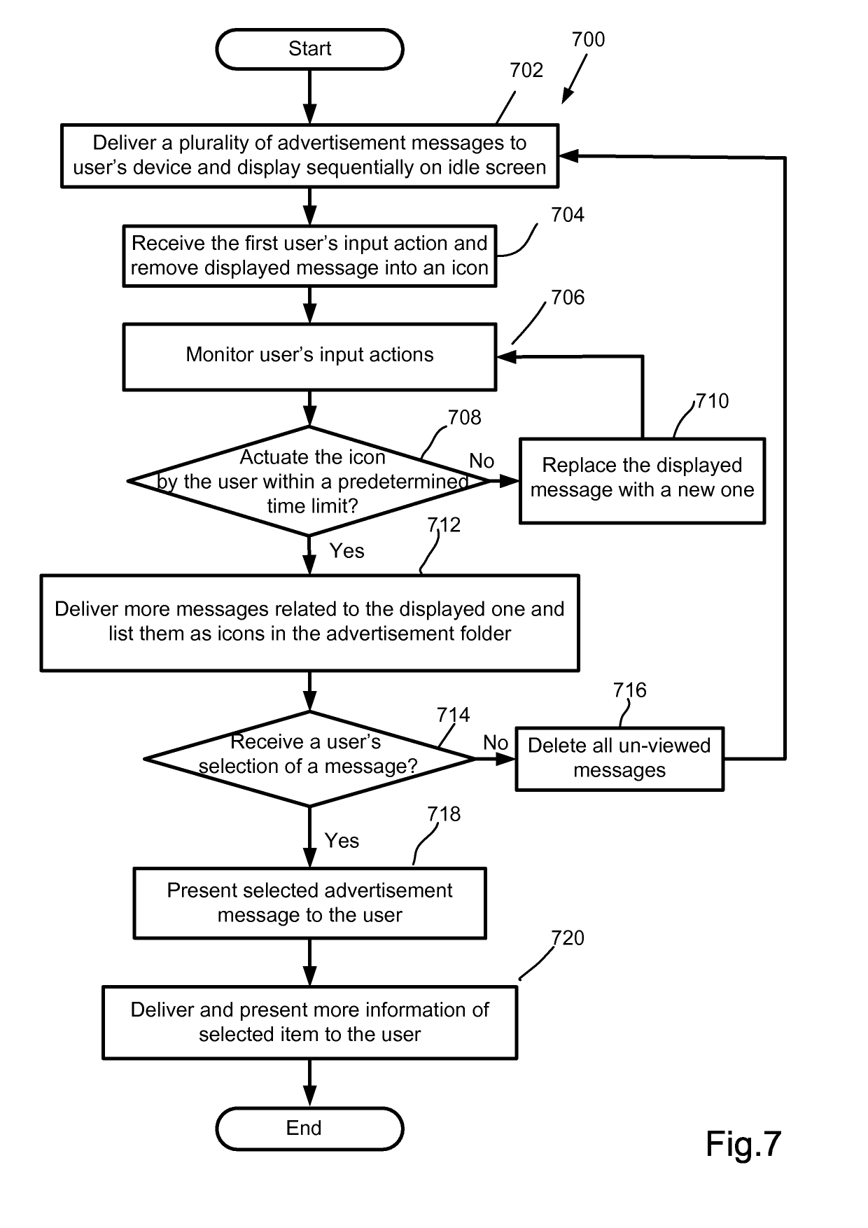

FIG. 7 is a flow diagram of an operation adjusting dynamically advertisement messages in the folder based upon the user's input actions. The process 700 starts by a step 702 that the server delivers advertisement messages to the mobile device. The messages are displayed sequentially when the idle screen status is detected. In a step 704, the displayed message is removed into the icon containing advertisement messages if the first user's input action after the device is in idling status is received. The processor monitors the user's further input actions in a step 706. If the user's input action is detected and the user does not actuate the icon for viewing the messages in a step 708 within a predetermined period of time, the displayed message is interpreted by the “advertisement message manager” as un-interested to the user. The message is then replaced by delivering a new one from the server in a step 710. If the user selects the icon within a predetermined period of time, the “advertisement message manager” interprets the message is interested to the user and sends the acknowledgement to the server and requests the server to deliver more advertisement messages related to the displayed one in a step 712. The received new messages from the server are displayed in the form of icons on the screen for the user to select from. After a predetermined period of time, if no user's further action is received in a step 714, all presented messages may be deleted in a step 716 and be replaced by new ones from the server. The inventive method establishes a dynamic means to find advertisement messages interested to the user. Any item failed to intrigue the user is replaced by a new one. On the other hand, messages related to the ones apparently interested to the user are sent to the device. If the user does select anyone of the messages in a step 718, more detailed information can be presented to the user by displayed more user selectable items on the screen in a step 720.

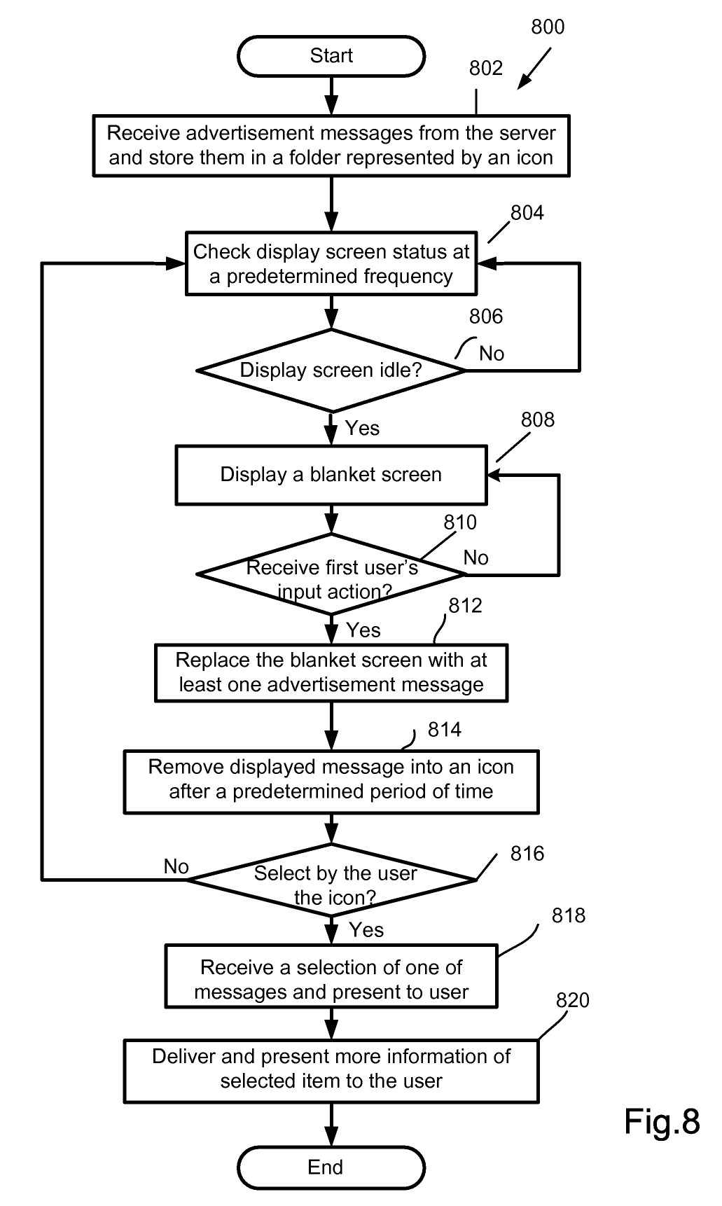

FIG. 8 is a flow diagram describing another embodiment for delivering and presenting advertisement messages to the user by the use of an idle screen that is taken as a blanket screen in an exemplary case. The process 800 starts by a step 802 that the server delivers advertisement messages to the mobile device. The “advertisement message manager” checks the status of the device at a predetermined frequency in a step 804. If the screen is detected in exceeding of a predefined time without the user's input actions in a step 806, a blanket screen is displayed in a step 808 in an exemplary illustration of the invention. A blanket screen helps the mobile device powered by a battery to conserve the energy. If the first user's input action after idling is received in a step 810, the blanket screen is then replaced by one of the advertisement messages displayed on the screen in a step 812. After a predetermined period of time, the message is removed automatically into an icon in the default display screen in a user's notable means in a step 814. Further, if the user selects the icon for viewing associated advertisement messages in a step 816, the “advertisement message manager” presents the selected message to the user in a step 818. Following by further input actions from the user, more detailed messages are presented to the user in a step 820.

1. A method of presenting one or a plurality of advertisement messages to a user using at least one electronic device terminal, the method comprising:
displaying at least one said message at a time and;
receiving a user's input action and;
removing the displayed message into a displayed icon in a notable means to said user.

2. The method as recited in claim 1, wherein said displayed icon representing a data file folder including at least said displayed message.

3. The method as recited in claim 1, wherein said “notable means” further comprising:
associating said displayed message with a display plane and;
showing a trajectory of said displayed plane moving into said icon while the size of said plane is being reduced progressively.

4. The method as recited in claim 1, wherein said “notable means” further comprising of accompanying the operation of said removing the message with an audio signal.

5. The method as recited in claim 1, wherein said “notable means” further comprising:
associating said displayed icon with a visual symbol representing said displayed message after said operation of removing said message and;
presenting visually notable changes of said visual symbol.

6. The method as recited in claim 1, wherein said method further comprising:
actuating said icon by said user and;
viewing said displayed message and/or;
viewing other advertisement messages in data file folder represented by the icon.

7. The method as recited in claim 1, wherein said method further comprising of deleting the displayed icon after a predetermined period of time if said user's actuation of the icon is not received.

8. The method as recited in claim 1, wherein said electronic device is connected to a server through a communication network.

9. The method as recited in claim 1, wherein said messages are delivered from the server and are stored in a folder represented by said icon.

10. A method of presenting one or a plurality of advertisement messages to a user using at least one electronic device terminal, the method comprising:
displaying at least one said message at a time and;
receiving a user's input action and;
removing the displayed message into a displayed icon in a notable means to said user and;
adjusting messages in a folder represented by said icon in accordance with said user's further input actions.

11. A method as recited in claim 10, wherein said “adjusting” operation further comprising:
replacing the displayed message if said device does not receive said user's action actuating said icon after a predetermined period of time and;
delivering at least one additional message from the server and presenting said message to said user if the device receives the user's action actuating the icon within a predetermined period of time.

12. A method as recited in claim 11, wherein said additional message is related to said displayed message.

13. A method as recited in claim 10, wherein said “adjusting” operation further comprising of replacing all messages in said folder if said user exits the folder without actions for viewing at least one message.

14. The method as recited in claim 10, wherein said electronic device is connected to a server through a communication network.

15. The method as recited in claim 10, wherein said messages are delivered from the server and are stored in a folder represented by said icon.

16. A method of presenting one or a plurality of advertisement messages to a user using at least one electronic device terminal, the method comprising:
displaying an idle screen and;
receiving a user's input action and;
displaying at least one message and;
removing the displayed message into a displayed icon in a notable means to said user.

17. The method as recited in claim 16, wherein said messages are stored in a folder represented by said icon, which are delivered from a server connected to the electronic device through a communication network.

18. The method as recited in claim 16, wherein said operation of displaying an idle screen is carried out after a predetermined period of time for not receiving a user's input action and for not receiving a calling message from said communication network.

19. The method as recited in claim 16, wherein said idle screen includes a blanket screen.

20. The method as recited in claim 16, wherein said displayed message including text, image, video and/or audio/video messages.
